(19) United States
(12) Patent Application Publication
(10) Pub. No.: US 2021/0365822 A1
(43) Pub. Date: Nov. 25, 2021

(54) Computer implemented method for generating generalized additive models

(71) Applicant: AKUR8, Paris (FR)

(72) Inventors: Guillaume BERAUD-SUDREAU, Paris (FR); Mattia CASOTTO, Paris (FR)

(73) Assignee: AKUR8, Paris (FR)

(21) Appl. No.: 17/107,689

(22) Filed: Nov. 30, 2020

(30) Foreign Application Priority Data
May 21, 2020 (FR) 2005423

(51) Int. Cl. G06N 7/00; G06F 17/13

(52) U.S. Cl. CPC G06N 7/005; G06F 17/13

(57) ABSTRACT

A computer implemented method which automatically generates sets of generalized additive models for data relative to biological information, environmental information, meteorological information, physical event information and geographical information.

### CROSS-REFERENCE TO RELATED APPLICATIONS

This application claims priority to French Application No. 2005423, filed May 21, 2020, titled “Computer implemented method for generating generalized additive models,” the disclosure of which is hereby incorporated by reference in its entirety.

### TECHNICAL FIELD

The invention concerns the field of statistics applied to physical applications. More precisely, it concerns a computer implemented method for generating generalized additive models (hereinafter GAMs, or GAM when singular).

### BACKGROUND

Some phenomena are only known through data and there is no scientific theory or body of research for characterizing it. This is particularly the case of environmental sciences.

There are usually three ways to approach the situations. The first one is the use black-box machine-learning techniques such as neural networks, random-forest, SVM, or Gradient Boosting Machine (GBM), etc. This approach has the disadvantage of being of the black box type, meaning that, once the model is in place, it is hard (usually impossible) to interpret and tweaking it is almost artistic. When one wants to actually understand the underlying relationships between the variables of the model, the second approach consists in trying to fit a regression in the form of a linear model, on the data. However, this second approach is complicated to put in place when there are many variables which need to be transformed to account for the non-linearity of their relations with the predicted variables, and it often leads to overly simplistic models. The third approach is to use additive models (GAMs). However, this is fundamentally human dependent and provides close to no automatability, as explained below.

As a result, there is no existing system to generate accurate and understandable models. GAMs (the third option above) are complicated to build, and generally rely heavily on the person building them and their knowledge of the data which is being modelized.

More precisely, it is necessary to manually select the subset of variables included in the models, and, for each one of these variables, model its exact effect or at least all the variable transformations allowing to change the GAM problem into a simpler linear modelling. This way to proceed is highly time-consuming: the number of variables to test is high (typically several hundreds) and the number of possible subsets of variables included in the models is extremely high. It is not feasible to test all the possible models, and thus a manual approach will only provide an approximation of the best model, leading to long and ineffective modelling. Manual variable selection relies on an informal stepwise algorithm, in which the modeler starts with an empty set of active variables, then adds a first variable based on his perception of the predictive power of the selected variable (adding it to the variables set leads to significant improvement of the predictions likelihood) or based on the knowledge of the modeler (the modeler knows that a given variable should impact the predicted variable). Then the effect of the variable must be determined and the effect functions optimized. Only then can the user iterate to add new variables.

Algorithms like the back-fitting technique illustrate a stepwise approach, but do not provide solutions for the variable selection problem (see for instance Hastie & Tibshirani: Generalized Additive Models, 1990). Indeed, this approach is only efficient with models containing a limited number of variables, is known to be sub-optimal (as variables contained in a small set might not be very relevant for larger set; this weakness is due to the greedy nature of the stepwise algorithm), and mixes quantitative and qualitative criteria which leads to modeler induced subjectivity biases. Furthermore, this technique does not provide variables selection, meaning there is still a heavy reliance on the modelers' biases.

### SUMMARY

The invention aims at improving the situation. To this end, the Applicant proposes a computer-implemented method for generating generative additive models comprising:
a) receiving a data set to be modeled as an input, each datum of said data set, being associated to a variable type indicating the nature of the datum, said variable type relating to information chosen in the group comprising biological information, environmental information, meteorological information, physical event information and geographical information, and each datum further having an associated variable value;
b) receiving a set of model inputs, including a number of input data set subsets, a lower model variable count, a higher model variable count, a parsimony number, and a smoothness number,
c) dividing the input data set into non-identical subsets, the number of said non-identical subsets being equal to said number of input data set subsets, and for each of said non-identical subsets and said input data set,
d) determining an upper parsimony value and a lower parsimony value, such that, upon determining a generalized additive model on said input data set or a subset thereof while using respectively said upper parsimony value and said lower parsimony value as a penalty parameter, the number of variables having a non-null coefficient substantially correspond to said lower model variable count and said higher model variable count, and deriving a set of parsimony values comprised between said upper parsimony value and said lower parsimony value, the number of parsimony values in said set of parsimony values being equal to said parsimony number,
e) determining a smoothness value based on said input data set, such that, upon determining a generalized additive model on a subset of said input data set while using said smoothness value as a penalty parameter, said model has the highest out-of-sample score, and determining a set of smoothness values comprised based on said smoothness value, the number of smoothness values in said set of smoothness values being equal to said smoothness number,
f)
   1. for each parsimony value in the set of parsimony values, determining a generalized additive model on said each of said non-identical subsets and said input data set while using said each parsimony value as a penalty parameter, and defining from the resulting model a set of active variables for which the coefficients are not null, thereby generating a number of sets of active variables equal to said number of input data set subsets plus one times said parsimony number, each of said sets of active variables being associated to a parsimony value and a subset or said input data set,
   2. for each smoothness value, for each set of active variables, determining a generalized additive model on the subset or said input data set associated to said each set of active variables while using said each smoothness value as a penalty parameter, thereby generating a number models equal to said number of input data set subsets plus one times said parsimony number times said smoothness number, each model being associated to a smoothness value, a parsimony value, and a subset or said input data set, and
g) grouping the generalized additive models which are associated to the same couple of associated parsimony value and smoothness value, computing the k-fold scores for each group of generalized additive models and returning for each group of generalized additive models the generalized additive model associated to said input data set as well as the corresponding k-fold scores.

In operations d), e) and f), determining a generalized additive model on a set of data using a penalty parameter includes optimizing a set of coefficients B=(b_{i,j}) such that:
the prediction of a generalized additive model is [symbol] (X)=g(Σ_{i∈A}Σⱼb_{i,j}*Iₓ_{ᵢ}₌ⱼ) where X is the input variable for the prediction, g( ) is a function which depends on the distribution sought after, A is the set of active variables and Iₓ_{ᵢ}₌ⱼ is the indicatrices function valued at 1 if xᵢ is the j^{th} level, and 0 in other cases,
the determination is based on optimizing the set of coefficients B taking into account constraints depending on the penalty parameter, using a proximal gradient descent algorithm, wherein the constraints are defined as B*=ArgMax_{B}LogLikelihood(Y, [symbol] )−Pₚₐᵣₛh(B) for operations d) and f1), where Pₚₐᵣₛ the penalty parameter and h( ) a penalty function, and as B*=ArgMax_{B}LogLikelihood(Y, [symbol] )−Pₛₘₒk(B) for operations e) and f2), where Pₛₘₒ is the penalty parameter and k( ) a penalty function.

This method is advantageous because it allows to create models in which the impact of one variable on the predictions does not depend on others. It allows to use the method of the invention to provide with a set of “as good as possible” models, which can later be tweaked in a controlled and understandable manner to fit a specific situation or goal. This is impossible with neural networks and GBM. Furthermore, the generation of the models is automated based on output criteria, and the variables are automatically selected according to these criteria. This means that there is no human interaction in the generation of the models, and that the variables that make up the output models are chosen “agnostically”: there is no bias in their selection, and only their statistical relevance to the data set allows their selection. As a result, the invention allows the best of both of the above-mentioned approaches: an automated, data-oriented model production, yet offering an accessibility for adjustments, as well as an understandability of the underlying variables strengths in the models.

In various embodiments, the method may present one or more of the following features:
in operation d) the set of parsimony values are defined by equally splitting using a logarithmic scale the range defined by said upper parsimony value and said lower parsimony value into a number of values equal to said parsimony number;
in operation e) the set of smoothness values are defined by defining a range between said smoothness value divided by 10 and said smoothness value multiplied by 10, and by equally splitting using a logarithmic scale said range into a number of values equal to said smoothness number;
function h(B) and/or k(B) comprise one element for category related parameters and another element for ordinated parameters;
function h(B) is defined as h(B)=Σ_{i∈Ord}\sqrt{Σⱼwⱼ(b_{i,j}−b_{i,j-1})²}+Σ_{i∈Cat.}\sqrt{ΣⱼWⱼb_{i,j}²}; and
function h(B) is defined as k(B)=Σ_{i∈Ord.}Σⱼwⱼ|b_{i,j}−b_{i,j-1}|+Σ_{i∈Cat.}Σⱼwⱼ|b_{i,j}|.

The invention also concerns a computer program comprising instructions for performing the method according to the invention, a data storage medium having recorded thereon this computer program and a computer system comprising a processor coupled to a memory having recorded thereon this computer program.

### BRIEF DESCRIPTION OF THE DRAWINGS

Other features and advantages of the invention will readily appear in the following description of the drawings, which show exemplary embodiments of the invention and on which:

FIG. 1 shows a generic diagram view of a system implementing the invention,

FIG. 2 shows an exemplary embodiment of the method executed by the system of FIG. 1,

FIG. 3 shows an exemplary embodiment of a function of FIG. 2,

FIG. 4 shows an exemplary embodiment of another function of FIG. 2,

FIG. 5 shows an exemplary embodiment of yet another function of FIG. 2,

### DETAILED DESCRIPTION

The drawings and the following description are comprised for the most part of positive and well-defined features. As a result, they are not only useful in understanding the invention, but they can also be used to contribute to its definition, should the need arise.

The description may make reference or use elements protected or protectable by copyright. The Applicant does not object to the reproduction of those elements in as much as it is limited to the necessary legal publications, however this should not be construed as a waiver of rights or any form of license.

For the sake of simplicity, in the below specification, the expression “model” will be used to designate a generalized additive model (GAM).

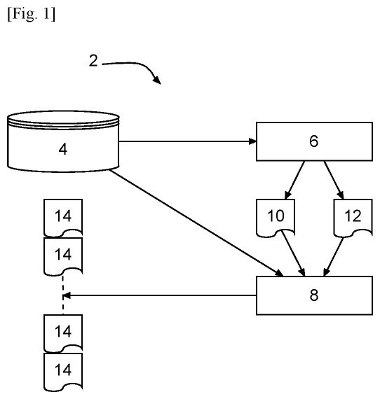

FIG. 1 shows a generic diagram view of a system 2 implementing the invention. The device 2 comprises a memory 4, a parameterizing unit 6 and a model building unit 8.

In the example described herein, the memory 4 may be realized in any way suitable, that is by means of a hard disk drive, a solid-state drive, a flash memory, a memory embedded in a processor, a distant storage accessible in the cloud, a combination thereof etc. Obviously, while FIG. 1 shows a single memory 4, there may be several memories, each of one or a combination of the above types.

The memory 4 stores data sets to be modelized. This data to be modelized forms a data set in which data are grouped together. The grouped data comprises for each datum a datum type and a datum value. The datum types constitute the variables or variables types which need to be chosen and fitted in order to build the generalized additive models according to the invention.

According to the invention, the variable types typically define biological information, environmental information, meteorological information, physical event information and geographical information. This means that any given variable type will be a physical quantity relating to these information categories. The memory 4 may also store data which does not relate to a physical quantity and may be viewed as arbitrary or abstract from a pure scientific point of view. This data may also used in the models generated according to the invention. However, these models will always comprise variables of the above variable types. This means that the invention will build models which always comprise variable types relating to physical quantities.

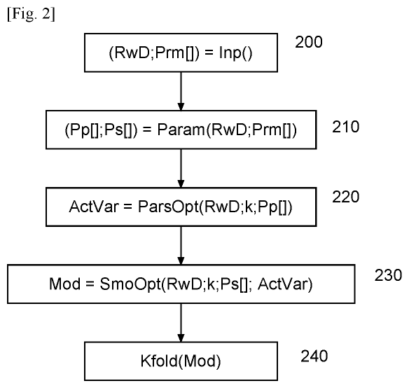

Besides the above described data set, memory 4 will also receive model parameters. As will appear below in reference to FIG. 2, these parameters include a lower model variable count, a higher model variable count, a parsimony number, a smoothness number, and a number of input data set subsets. While all these parameters can be changed for any new modeling procedure, they may also be fixed, or offered in groups to the user who chooses them.

These parameters are intricately linked to the fact that the invention aims at automatically generating highly relevant generalized additive models. In order to better understand them, generalized additive models and their challenges will be quickly discussed.

GAMs are predictive models following an additive structure. The prediction 9 is a sum of functions of the explanatory variables xᵢ, which translate mathematically in the following equation:

ŷ(X)=g(Σ_{i∈A}ƒᵢ(xᵢ)) [Math 1]

where ŷ(X) is the prediction of the model, g( ) is a linking function which is usually chosen according to the asserted distribution of the data, A is the set of active variables on which the modelling is performed, xᵢ is the value of the ith variable of X and ƒᵢ are the fitting functions.

The prediction of a GAM thus depends mainly on the limited set of active variables A, which is a subset of all the variables available in the data set, and their effects are not dependent of other variables.

This independence of the effect of each variable is a great advantage, because it allows GAMs to be understandable, as opposed to neural networks or other black box type models for example.

This establishes the main challenge when building a GAM: the more the variable types in the set of active variables, the more precise the modelling—and the overfitting risk to some extent—but also the less understandable the resulting model.

So, unlike other machine-learning systems, an efficient GAM should not only maximize the predictive power of the model, but also minimize the number of active variables. And in addition to choosing an optimal set of active variables, the effects (functions ƒᵢ) associated to each one of them also needs to be defined. As the data used to build the models is necessarily noisy, the functions ƒᵢ need to provide a good denoising property.

In view of these challenges, the lower model variable count and the higher model variable count are parameters which respectively indicate the minimum and the maximum number of variables that an output model may contain. This means that, if the data set comprised 50 variable types and that those parameters are set to 5 and 30, then the resulting models will based on the data associated to between 5 to 30 of these variables, and that the other data will not be taken into account for the purposes of building the models. The number of variables in the set of active variables will thus be allowed to vary between the lower model variable count and the higher model variable count.

As expressed above, GAMs are by nature built on tradeoffs. There is no single “right” GAM for a given data set. As a result, the invention aims at generating groups of models, which can be compared and analyzed in order to keep one or more GAMs which fit different modelling needs.

The parsimony number and the smoothness number allow to parametrize these groups of models. The parsimony number is the amount of different number of variables in the set of active variables to be used. This means that, if the lower model variable count and the higher model variable count are parameters are set of 5 and 30, and the parsimony number is set to 7, then there will be 7 groups of GAMs generated, which each have a set of active variables which number is substantially comprised between 5 and 30. For example, the resulting groups of models will have a number of active variables chosen in the following list {5; 12; 15; 20; 24; 27; 30}. Then, the smoothness number defines the number of different models within a given group of models. This allows, the a given number of variables of a set of active variables, to generate models which offer different levels of denoising. As a result, following the above example, if the smoothness number is set to 5, then a total of 35 models will be generated. Each group, having a number of active variables chosen in the above list, will contain 5 models. This allows to return the group of models in an easily interpretable manner, since the models can be compared by groups, and also within a group.

To make matters worse, this is only half of the way, as finding the optimal functions ƒₗ is equally challenging. Optimizing over simple parametric functions (such as polynomial or splines) would be very easy to do but such functions are known to be suboptimal and require a large amount of fine tuning, which cannot be automated. In order to generate efficient GAMs, the Applicant has discovered that it is preferable to use are non-parametric, so-called “simple functions”, defined by their values in all the levels present in the data.

Using simple functions also allow simple interactions between the user and the model: the user needs the capability to manually fine-tune the resulting models where the extrapolation generated by the machine-learning algorithm might not be coherent with the user knowledge. This fine-tuning can be done by modifying the values of simple functions (while polynomial or splines would be impossible to modify in an intuitive way by a human). However, optimizing simple functions leads to a complex optimization problem, as they are defined by all their values. As a result, finding an optimal function leads to the optimization of a very large number of parameters.

To offer a real-life example of the complexity, if one wishes to build a model containing 20 variables out of 200, the number of possible sets of active variables would be 1.6*10²⁷. The combination of parsimony levels with smoothness levels leads to a “grid-search” approach: the user doesn't know in advance the exact properties of the model he wants to generate, so he will generate a large number of models and pick the most relevant one for his use-case.

The number of input data set subsets is a parameter which is linked to the scoring of the models between them. As will appear below, the system 2 uses a k-fold cross validation, where k is the number of input data set subsets. This means that k+1 models are actually fitted: k models, on a (k−1)/k rolling window on the data set, each tested on the remaining 1/k of the data set for out-of-sample performance scoring, and one model created on the full data set. While the number of input data set subsets is presented as a parameter, it may well be fixed. It is for instance fairly conventional to run a 4-fold modelling.

The parameterizing unit 6 and the model building unit 8 are in the example described herein computer programs which are executed on one or more processors. Such processors include any means known for performing automated calculus, such as CPUs, GPUs, CPUs and/or GPUs grids, remote calculus grids, specifically configured FPGAs, specifically configured ASICs, specialized chips such as SOCs or NOCs, AI specialized chips, etc.

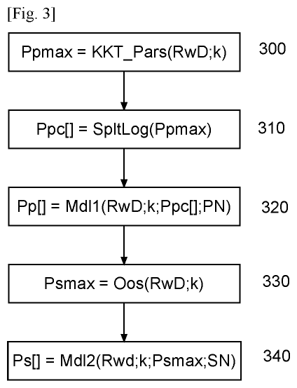

The functional nature of the parameterizing unit 6 and the model building unit 8 should be noted and understood. While the specification presents them as separate units, they may be united in a single program. Furthermore, as will appear with reference to FIGS. 3 to 5, both the parameterizing unit 6 and the model building unit 8 rely on the building of models using a similar algorithm, with mainly the parameters and the input data changing, and some different works on the outputs. They could thus be seen as units which do not do any modelling themselves and leverage a modelling unit.

Due to its nature, the system 2 is particularly suited for a cloud type implementation, as will appear from the below description of FIGS. 2 to 5.

FIG. 2 shows an exemplary embodiment of the method executed by the system. It starts with the execution of an input function Inp( ) in an operation 200. Function Inp( ) is an input function in which a data set RwD to be modelized and the modelling parameters Prm[ ] are entered as arguments and will be used as a global variable in the other steps.

The modelling parameters Prm[ ] may include some of all of the below parameters:
a target variable, that will be predicted (y above),
a number of input data set subsets (hereinafter k),
a lower model variable count (hereinafter vcmin),
a higher model variable count (hereinafter vcmax),
a parsimony number (hereinafter PN), and
a smoothness number (hereinafter SN).

This can be done by means of a human machine interface (HMI) in which a user enters each or some of the above parameters. This can be done by entering values and/or choosing from a list. The fields may also be pre-populated. Any type of HMI which can be used as long as it offers an interface through which the user can input the relevant parameters. Furthermore, if a user does not enter a given parameter, a default value may be retained.

Once the initialization has been done, the parameterizing unit 6 is called in an operation 210 in order to determine hidden modelling parameters from the input parameters. These hidden parameters are respectively referenced 10 and 12 on FIG. 1.

This is done by a function Param( ) which receives the data set RwD and the modelling parameters Prm[ ] from operation 200 as arguments, and returns two lists of values Pp[ ] and Ps[ ] which will be described in further detail with reference to FIG. 3.

In order to better understand these hidden parameters, the modelling needs to be explained in more details.

The model building according to the invention consists in finding a set of parameters B=(b_{i,j}), defining functions ƒᵢ such as: ƒᵢ(xᵢ)=Σⱼb_{i,j}Iₓ_{ᵢ}₌ⱼ and thus, for each observation X, a prediction:

[symbol]

(X)=g(Σ_{i∈A}ƒᵢ(xᵢ))=g(Σ_{i∈A}Σⱼb_{i,j}Iₓ_{ᵢ}₌ⱼ) [Math 2]

The function g is a pre-defined input, provided by the user or automatically (typically, the identity, exponential or logistic function). The Applicant has noted that function g often corresponds to the distribution of the data set: if the distribution is gaussian, then g is usually the identity function, if the distribution is of the Poisson or Gamma type, then g is usually the exponential function, and if the distribution is of the Bernoulli type, then g is usually the logistic function.

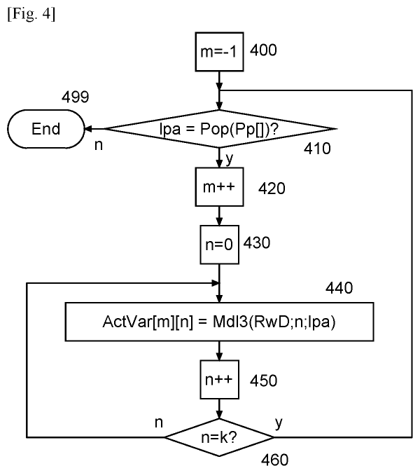

The set of active variables A is automatically defined (as will be explained further below with reference to FIG. 4). The exclusion of a variable from the set of active variables A can be done by setting its function ƒᵢ or setting all its coefficients b_{i,j} to zero.

The function Iₓ_{ᵢ}₌ⱼ is the indicatrices function valued at 1 if xᵢ is the j^{th} level, and 0 in other cases.

The optimization of these models, taking into account the above, means that three objectives have to be concurrently followed:
Maximize the likelihood of the predictions,
Maximize the “smoothness” of the model's functions ƒᵢ, and
Maximize the parsimony of the model—respect the constraints on the number of variables in the sets of active variables.

These objectives can be optimized simultaneously as a penalized regression. The weight of the two penalties translate the importance of each constraints:

B*=ArgMax_{B}LogLikelihood(Y, [symbol] )−λₛₘPenalty_{Smoothness}(B) with vcmin≤Card(A)≤vcmax [Math 3]

When researching, the Applicant discovered that, if applied directly, the optimization of the penalties related to smoothness and parsimony is not always solvable problem. In order to address this problem, the Applicant discovered that the optimization can be performed serially, by first optimizing a parsimony related penalty, and then optimizing a smoothness related penalty. The problem above is thus reformulated as the optimization in two phases.

First, the parsimony penalty is optimized:

B*=ArgMax_{B}LogLikelihood(Y, [symbol] )−λₚₐPenalty_{parsimony}(B) [Math 4]

Where ArgMax_{B} and LogLikelihood(Y, [symbol] ) are well-known functions, λₚₐ is the one of the hidden parameters, hereinafter parsimony penalty parameter, and Penalty_{Parsimony}(B) is a penalty function which will be described in more detail with respect to FIG. 4.

Then, for all the functions in the set of active variables thereby determined, the smoothness penalty is optimized and the functions ƒᵢ are fitted

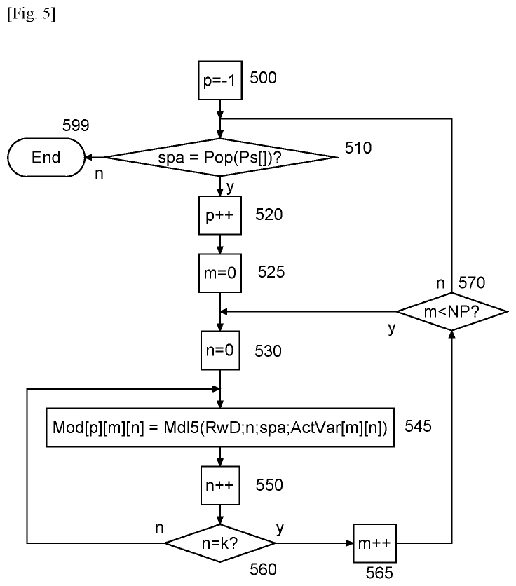

B*=ArgMax_{B}LogLikelihood(Y, [symbol] )−λₛₘPenalty_{Smoothness}(B) [Math 5]

Where ArgMax_{B} and LogLikelihood(Y, [symbol] ) are well-known functions, λₛₘ is the one of the hidden parameters, hereinafter smoothness penalty parameter, and Penalty_{Smoothness}(B) is a penalty function which will be described in more detail with respect to FIG. 5.

Because the penalty parameters λₚₐ and λₛₘ are not known a-priori, it is necessary to determine ranges to look for them. In other words, the efficiency of the models will be influenced by the values of those penalty parameters. At the same time, they are the only parameters to define in the above equations. As a result, in order to optimize the models, the function Param( ) searches for ranges of relevance for the penalty parameters, and defines therefrom list of values for the parsimony penalty parameter and the smoothness penalty parameter.

Then, the above two phases optimization can be performed with the lists of penalty parameter values, in order to build the models, as will be explained in reference to FIG. 4.

FIG. 3 shows an exemplary embodiment of the function Param( ).

This function starts in an operation 300 with the execution of a function KKT_Pars( ) which receives the data set RwD and the number of input data set subsets k as arguments, and returns a value Ppmax.

The function KKT_Pars( ) uses the Karush-Kuhn-Tucker conditions in order to identify the first value of λₚₐ such that, in a model resulting from the optimization of formula Math 4 above, the set of active variables (that is the variables for which at least one coefficient is not null) is equal to 0. One way to compute KKT_Pars( ) is to solve the dual of equation Math 5 with B equal to 0, and to find the lowest value of lambda such that the formula is optimal. This can be done by computing the dual norm (or its Fenchel transformation, when dual norm is not available), corresponding to the parsimony penalty, on the derivative of the likelihood term (computed at B=0) of formula Math 4.

In an alternative embodiment, Ppmax may be determined differently, for instance as the first value which yields a set of active variables containing at least 3 or 5 variables, as long as the number is lower than the lower model variable count. This alternative embodiment is interesting because the models according to the invention will almost always have more than 5 variables in order to be sufficiently precise, and, in that regards, it is not absolutely necessary to have a Ppmax value corresponding to exactly zero variables if it allows to perform operation 300 faster.

Then, in an operation 310, a function SpltLog( ) is executed to calculate the set of values which will be tested. This function receives the value Ppmax as an argument and returns a table of values which are to be tested to determine ranges for the λₚₐ values. In the example described herein, this is done by taking the value Ppmax and dividing it by 10\hat{ }4. Then, 50 values are determined, equally split according to a logarithmic scale between Ppmax and Ppmax divided by 10\hat{ }4, and stored in a vector Ppc[ ]. Of course, there may be more than 50 values or less, and the lower bound for the Ppc[ ] vector may be chosen different than 1/10\hat{ }4 of Ppmax. As appears, the general idea is to determine a range of values which is sufficiently large to encompass the best likely value for the parsimony penalty parameter, and to split this range evenly to explore it.

Based on the values in vector Ppc[ ], a function Mdl1( ) is run in an operation 320. Function Mdl1( ) receives the data set RwD, the number of input data set subsets k and the vector Ppc[ ] as arguments, and returns a list of values Pp[ ] for the parsimony penalty parameter which will be used for the first phase of modelling.

In order to do so, function Mdl1( ) takes every value in table Ppc[ ], and runs an optimization of formula Math 4 on a subset of data set RwD, for instance the first one, as defined together with the number of input data set subsets k. For each resulting model, the number of variables having at least one non null coefficient is determined, and the two values which are closest to respectively the lower model variable count vcmin, and the higher model variable count vcmax are retained. Alternatively, the input data set may be used in its entirety, as opposed to fitting on a subset thereof.

Functionally speaking, these values are the two parsimony penalty values which ensure that the number of variables in an active set optimizing the parsimony optimization equation Math 4 will encompass the range [vcmin; vcmax] of the third objective.

Then, to prepare the first phase of the modelling, the list of values Pp[ ] is established similarly to operation 310 by equally splitting the range defined by the two determined parsimony penalty values into a number of values equal to the parsimony number NP, using a logarithmic scale. Here again, the list of values Pp[ ] may be established in a different manner.

After that an operation 330 executes a function Oos( ) which receives the data set RwD and the number of input data set subsets k as arguments, and returns a value Psopt.

The value Psopt is determined by function Oos( ) as the value of λₛₘ yielding the highest out-of-sample score on a subset of the input data set, for instance the first one.

In order to perform this determination, function Oos( ) will first determine a value Psmax in a similar manner to Ppmax (only the penalty function differs). Once Psmax is determined, a range corresponding to [Psmax/10\hat{ }4; Psmax] is built, and 50 candidate values are extracted in this range, equally split on a logarithmic scale. For each of these candidate values, function Oos( ) thereafter fits a model using the maximum number of selected variables at parsimony step based on formula Math 5. The result Psopt is then determined as the one which model has the highest out-of-sample score on the remaining data of the input data set.

Finally, the function Mdl2( ) a function receives the data set RwD, the number of input data set subsets k and the value Psopt as arguments, and returns a list of values Ps[ ] for the smoothness penalty parameter which will be used for the second phase of modelling.

Function Mdl2( ) first determines a range of values by dividing the value Psopt by 10 and by multiplying it by 10. Of course, there may be more than 10 values or less. Then, similarly to operation 320, this range is split into a list Ps[ ] containing of values equal to the smoothness number SN, split equally according to a logarithmic scale. The list of values Ps[ ] represents the smoothness penalty values which will be used in the second phase. Here again, the list of values Ps[ ] may be established in a different manner.

As appears from the above, operation 300 to 330 have to be performed sequentially, and operation 320 contains operations which may be parallelized. In the same manner, operation 330 and 340 have to be performed sequentially, and operation 330 contains operations which may be parallelized.

Once operation 210 is finished, the hidden parameters have been determined, and the two phases can be executed. The first phase is executed in an operation 220, in which a function ParsOpt( ) is executed by the model building unit 8.

Function ParsOpt( ) receives the input data set RwD, the number of input data set subsets k and the list of values Pp[ ] as arguments, and returns a matrix ActVar of sets of active variables which are each associated a couple comprising one of the parsimony penalty values of list Pp[ ] and a reference indicating which subset of the input data set (or the input data set itself) has been used in conjunction with that parsimony penalty value to generate this set of active variables.

FIG. 4 shows an exemplary embodiment of function ParsOpt( ). This function contains two loops. A first loops progressively pops the list of values Pp[ ], and the second loop generates a model for each subset of the input data set and for the input data set as a whole, and determines and stores each time the set of actives variables of the resulting models in a matrix ActVar.

The first loop begins in an operation 400 which initiates an index m to 0. Then in an operation 410, the list of values Pp[ ] is popped. If the list is empty, then all sets of active variables have been generated, and the function ends in a operation 499 returning the matrix ActVar.

Else, the value lpa is popped from the list Pp[ ], the index m is incremented in an operation 420, and the second loop is initiated by setting an index n to 0 in an operation 430.

Then, in an operation 440, a function Mdl30 is called with the input data set RdW, the index n and the parsimony penalty value lpa. In return, this function fills the matrix ActVar with a set of active variables at coordinates corresponding to index m and index n.

Operation 440 optimizes formula Math 4 on a subset of input data set RwD if n is strictly inferior to number of input data set subsets k, and on the input data set entirely if n is equal to k.

In the above, the function Penalty_{Parsimony( )} has been voluntarily eluded in order to simplify the understanding. It will now be described in more detail in order to better understand the optimization which is performed.

The Applicant has discovered that the third objective can be managed by including a penalty in the optimization of the set of coefficients, according to a Lagrangian approach. A naïve penalty would be to simply follow the number of non-null functions present in the model (the size of the set of active variables A): Penalty_{Parsimony}(B)=Σᵢ∥bᵢ∥₀, so the penalty value is just the number of variables included in the model). However, as mentioned above, finding a set of variables maximizing both the likelihood and this penalty is not an algorithmically solvable problem (it is NP-hard).

In order to achieve a computationally solvable problem, the Applicant uses the following definition for function Penalty_{Parsimony}( ):

Penalty_{Parsimony}(B)+Penalty_{Parsimony ord.}(B)=Penalty_{Parsimony cat.}(B) [Math 6]

The Penalty_{Parsimony ord.}(B) function can be defined as follows:

Penalty_{Parsimony ord.}(B)=Σ_{i∈Ord}\sqrt{Σⱼwⱼ(b_{i,j}−b_{i,j-1})²} [Math 7]

Where the wⱼ are weights which will be defined in more detail with respect to formula Math 10 below.

In an alternative embodiment, the parsimony penalty function of formula Math 7 may be defined as Σ_{i∈cat.}ΣⱼMaxⱼ(wⱼ|b_{i,j}−b_{i,j-1}|).

The Penalty_{Parsimony cat.}(B) function can be defined as follows:

Penalty_{Parsimony cat.}(B)=E_{i∈Cat.}\sqrt{Σⱼwⱼb_{i,j}²} [Math 8]

As a result, this penalty function measures the norm two of the empirical derivative of the functions ƒᵢ. This measure is comparable to a group-lasso penalty, applied to the derivatives of the functions ƒᵢ. Such a penalty provides an efficient way to group at zero functions of a variable if no contiguous partition of its levels is significant enough. It can be seen as a convex relaxation of the “naïve” penalty described above.

In an alternative embodiment, the parsimony penalty function of formula Math 8 may be defined as Σ_{i∈Cat.}ΣⱼMaxⱼ(wⱼ|b_{i,j}|).

Until now, the Applicant has also voluntarily remained silent on the method used to perform the optimization of formulas Math 4 and Math 5, again in order to simplify the understanding.

When looking at formulas Math 4 and Math 5, they both comprise two terms. The first, the likelihood, is pretty known in statistics and alone can be solved using conventional algorithms such as gradient descent, or stochastic gradient descent when the database is huge and hence an approximation of the computed gradient must be used to obtain results in reasonable amount of time. However, the second term, respectively the parsimony penalization and the smoothness penalization, pose optimization challenges due to their non-differentiability.

In order to solve this optimization problem, the Applicant has discovered that proximal gradient descent algorithm are very efficient. In the example described here, the Applicant uses a modified version of the SAGA algorithm. This modified version, named VR-TOS, is described in the article by Pedregosa, Fatras and Casotto “Proximal Splitting Meets Variance Reduction”, Proceedings of the 22nd International Conference on Artificial Intelligence and Statistics 2019, arXiv:1806.07294 [math.OC]. Other methods may be used to perform the optimization, such as using ADMM, FISTA, Prox SVRG algorithms.

Once the model is built, the set of active variables is determined from the variables for which at least one coefficient is not null, and this set of active variables is stored in the matrix ActVar at the coordinates for parsimony penalty value lpa and index n.

Then index n is incremented in an operation 450 and an exit condition of the second loop is tested in an operation 460. If all the sets of active variables have been generated, then the list Pp[ ] is popped again in operation 410. Else, the second loop is reiterated with operation 440.

Now that the set of active variables has been identified in operation 220, the second phase of the modelling can be executed, by performing a similar operation, but on the formula Math 5, and taking into account all of the smoothness values of the list Ps[ ]. This is done in an operation 230 by a function SmoOpt( ) which receives the input data set RwD, the number of input data set subsets k, the list of values Ps[ ] and the matrix ActVar as arguments, and returns a matrix of models Mod, each associated to a triplet comprising one of the smoothness penalty values of list Ps[ ], one of the parsimony penalty values of list Pp[ ] and a reference indicating which subset of the input data set (or the input data set itself) has been used to generate this model.

FIG. 5 shows an exemplary embodiment of function SmoOpt( ). It is very similar to FIG. 4, except that it further includes a third loop to take into account the matrix ActVar. As a result, where function ParsOpt( ) generated NP*(k+1) sets of active variables, function SmoOpt( ) generates SP*NP*(k+1) models.

The operations which are similar the FIG. 4 share the same last two reference digits and will not be described in further detail. The operations which are new of different have their last reference digit set to 5.

The main differences lie in operation 525 to set the index of the third loop to 0 (linked to the parsimony values), operation 565 to increment this index and operation 570 to check whether all set of active variables for all parsimony values have been used.

The last difference relates to operation 545, which is a variant of operation 440. Indeed, this operation executes a function Mdl4( ), which receives input data set RwD, index n, smoothness penalty value spa and the active set of variables ActVar[m][n] corresponding to the current index n and m of the second and third loops respectively.

While FIG. 4 and FIG. 5 have been presented in a iterative manner, it will be readily apparent that they can be massively parallelized, since all of the loops and operations within loops are independent from one another.

Function Mdl4( ) uses the same algorithm as function Mdl3( ) in order to optimize formula Math 5, with the restriction that the set of active variables are in this case set to those of ActVar[m][n]. This allows for a quicker convergence and to build models having the number of variables as required by the user.

In the above, the function Penalty_{Smoothness}( ) has been voluntarily eluded in order to simplify the understanding. It will now be described in more detail in order to better understand the optimization which is performed.

The variables can be different nature: for an ordered variable, the structure (consecutive levels) of the variables should be taken into account in the smoothness definition, whereas for a categorical variable, each level should be treated independently.

As a result, the smoothness criteria is split in two:

Penalty_{Smoothness}(B)=Penalty_{Smoothness ord.}(B)+Penalty_{Smoothness cat.}(B) [Math 9]

The following will describe the Penalty_{Smoothness ord.}(B) function. The sum, for all ordered variables, of the norm 1 of its 1^{st} derivative, can be simplified as:

Penalty_{Smoothness ord.}(B)=Σ_{i∈Ord.}Σⱼwⱼ|b_{i,j}−b_{i,j-1}| [Math 10]

where Ord. is the set of all the ordinal variables available in the data set.

In other words, the smoothness is the sum of the absolute value of the difference between consecutive coefficients. This is comparable to the penalty used by the total-variation algorithm, used in particular in signal processing. However, departing from the standard total-variation algorithm, formula Math 10 provides a weighted version of the problem. The weights wⱼ are computed using the distribution of the variable in the input data set. They can be chosen in a way that approximates the inverse of the square root of the information matrix, a quantity used in GAM statistical analysis to describe second-order properties of the models built. More precisely, wⱼ are weights chosen such that the optimization of formula Math 10 through a constrained optimization of the type H(beta)<=lambda leads to H(beta) being substantially equal to the Chi square statistical test.

This objective function corresponds to an a-priori hypothesis on the shape of the functions ƒᵢ which is that the difference between their consecutive coefficients—a proxy for its derivative—follows a Laplace function: (b_{i,j}−b_{i,j-1})˜∝e^{-λ}^{ₛₘ}^{|b}^{_{i,j}}^{-b}^{_{i,j−1}}^{|}. It also shares a lot of similarities with the Lasso algorithm; as the coefficients b_{i,j} are applied to a binary encoding of the data—through the use of indicatrices functions—the nullity of coefficients b_{i,j} directly relates to statistical tests, as for the Lasso algorithm—which motivates the modelling process described above.

Using this type of penalties—which generate a sparse derivative for the functions ƒᵢ—helps building models which are easier to interpret, as non-relevant coefficients are set at exactly the same level (so their levels are actually grouped together). This means that the user will only have to review a limited number of levels, and base his analysis on binary decisions—whether coefficients are grouped or not.

In an alternative embodiment, the more conventional norm two square penalty could be used, which would be akin to a ridge regression instead of a Lasso, and would allow the generation of smooth functions. It would however forego the easier interpretability advantage, as all the coefficients would be different one from another.

The following will describe the Penalty_{Smoothness cat.}(B) function. The invention relies here on a classical Lasso paradigm to leverage non-ordered variables.

For these variables, the smoothness penalty is set as:

Penalty_{Smoothness cat.}(B)=Σ_{i∈Cat.}Σⱼwⱼ|b_{i,j}| [Math 11]

where Cat. is the set of all the categorical variables available in the input data set.

Once operation 230 is finished, all of the models are available to be presented to the user for him to make his choice. In order to help the user in his grid-search, the k-fold is leveraged in an operation 240, in which a function Kfold( ) is executed. This function receives the matrix of models Mod as an input and returns a display of the models ordered by number of variables, with their respective k-fold score.

Simply put, function Kfold( ) regroups all the models associated to a given couple (parsimony value, smoothness value) of matrix Mod, and performs a k-fold cross validation on the models which were obtained on subsets of the input data set. The model presented to the user is the model obtained on the input data set as a whole, and the k-fold scores of each subset model is accessible, as well as the average. This cross validation can be made in the form of a Gini score, an EDR metric, a Deviance score, etc. The grid search is advantageous because the user can quickly navigate to make his tradeoff between the generalized additive models generated—the higher the parsimony value, the more complex to understand the model, and the higher the score, the better the efficiency of the model.

Of course, the grid-search can be made interactive, such that a user selecting a given model corresponding to a parsimony value and a smoothness value can see all of the elements of the corresponding model, such as the set of active variables, the values of all of the coefficients, in depth metrics analysis tools such a the Lorenz curve and the Lift curve, etc. Furthermore, this allows to offer a tuning interface for the users. More precisely, based on a chosen model, the user may alter some of the coefficients of the model, and witness immediately the impact this has on the predictions and on the k-fold scores.

In view of the above, the invention allows to generate generalized additive models in a reliable, automated and optimal manner, while guaranteeing understandable tradeoffs for a user. This allows to quickly develop highly reliable and efficient models including physical quantity variables in a way that has never been possible before.

1. A computer implemented method for generating generative additive models comprising:
a) receiving a data set to be modeled as an input, each datum of said data set, being associated to a variable type indicating the nature of the datum, said variable type relating to information chosen in the group comprising biological information, environmental information, meteorological information, physical event information and geographical information, and each datum further having an associated variable value;
b) receiving a set of model inputs, including a number of input data set subsets, a lower model variable count, a higher model variable count, a parsimony number, and a smoothness number,
c) dividing the input data set into non-identical subsets, the number of said non-identical subsets being equal to said number of input data set subsets, and for each of said non-identical subsets and said input data set,
d) determining an upper parsimony value and a lower parsimony value, such that, upon determining a generalized additive model on said input data set or a subset thereof while using respectively said upper parsimony value and said lower parsimony value as a penalty parameter, the number of variables having a non-null coefficient substantially correspond to said lower model variable count and said higher model variable count, and deriving a set of parsimony values comprised between said upper parsimony value and said lower parsimony value, the number of parsimony values in said set of parsimony values being equal to said parsimony number,
e) determining a smoothness value based on said input data set, such that, upon determining a generalized additive model on a subset of said input data set while using said smoothness value as a penalty parameter, said model has the highest out-of-sample score, and determining a set of smoothness values comprised based on said smoothness value, the number of smoothness values in said set of smoothness values being equal to said smoothness number,
f)
1. for each parsimony value in the set of parsimony values, determining a generalized additive model on said each of said non-identical subsets and said input data set while using said each parsimony value as a penalty parameter, and defining from the resulting model a set of active variables for which the coefficients are not null, thereby generating a number of sets of active variables equal to said number of input data set subsets plus one times said parsimony number, each of said sets of active variables being associated to a parsimony value and a subset or said input data set,
2. for each smoothness value, for each set of active variables, determining a generalized additive model on the subset or said input data set associated to said each set of active variables while using said each smoothness value as a penalty parameter, thereby generating a number models equal to said number of input data set subsets plus one times said parsimony number times said smoothness number, each model being associated to a smoothness value, a parsimony value, and a subset or said input data set, and
g) grouping the generalized additive models which are associated to the same couple of associated parsimony value and smoothness value, computing the k-fold scores for each group of generalized additive models and returning for each group of generalized additive models the generalized additive model associated to said input data set as well as the corresponding k-fold scores,
wherein, in operations d), e) and f), determining a generalized additive model on a set of data using a penalty parameter includes optimizing a set of coefficients B=(b_{i,j}) such that:
the prediction of a generalized additive model is [symbol] (X)=g(Σ_{i∈A}Σⱼb_{i,j}*Iₓ_{ᵢ}₌ⱼ) where X is the input variable for the prediction, g( ) is a function which depends on the distribution sought after, A is the set of active variables and Iₓ_{ᵢ}₌ⱼ is the indicatrices function valued at 1 if xᵢ is the j^{th} level, and 0 in other cases,
the determination is based on optimizing the set of coefficients B taking into account constraints depending on the penalty parameter, using a proximal gradient descent algorithm, wherein the constraints are defined as B*=ArgMax_{B}LogLikelihood(Y, [symbol] )−Pₚₐᵣₛh(B) for operations d) and f1), where Pₚₐᵣₛ is the penalty parameter and h( ) a penalty function, and as B*=ArgMax_{B}LogLikelihood(Y, [symbol] )−Pₛₘₒk(B) for operations e) and f2), where Pₛₘₒ is the penalty parameter and k( ) a penalty function.

2. A computer implemented method according to claim 1, wherein in operation d) the set of parsimony values are defined by equally splitting using a logarithmic scale the range defined by said upper parsimony value and said lower parsimony value into a number of values equal to said parsimony number.

3. A computer implemented method according to claim 1, wherein in operation e) the set of smoothness values are defined by defining a range between said smoothness value divided by 10 and said smoothness value multiplied by 10, and by equally splitting using a logarithmic scale said range into a number of values equal to said smoothness number.

4. A computer implemented method according to claim 1, wherein function h(B) and/or k(B) comprise one element for category related parameters and another element for ordinated parameters.

5. A computer implemented method according to claim 4, wherein function h(B) is defined as h(B)=Σ_{i∈Ord}\sqrt{Σⱼwⱼ(b_{i,j}−b_{i,j-1})²}+Σ_{i∈Cat.}\sqrt{Σⱼ wⱼb_{i,j}²}.

6. A computer implemented method according to claim 4, wherein function h(B) is defined as k(B)=Σ_{i∈Ord.}Σⱼwⱼ|b_{i,j}−b_{i,j-l}|+Σ_{i∈Cat.}Σⱼwⱼ|b_{i,j}|.

7. (canceled)

8. (canceled)

9. A non-transient computer readable medium having instructions that, when executed, cause a processor to:
a) receive a data set to be modeled as an input, each datum of said data set being associated to a variable type indicating the nature of the datum, said variable type relating to information chosen in the group comprising biological information, environmental information, meteorological information, physical event information and geographical information, and each datum further having an associated variable value;
b) receive a set of model inputs, including a number of input data set subsets, a lower model variable count, a higher model variable count, a parsimony number, and a smoothness number,
c) divide the input data set into non-identical subsets, the number of said non-identical subsets being equal to said number of input data set subsets, and for each of said non-identical subsets and said input data set,
d) determine an upper parsimony value and a lower parsimony value, such that, upon determining a generalized additive model on said input data set or a subset thereof while using respectively said upper parsimony value and said lower parsimony value as a penalty parameter, the number of variables having a non-null coefficient substantially correspond to said lower model variable count and said higher model variable count, and deriving a set of parsimony values comprised between said upper parsimony value and said lower parsimony value, the number of parsimony values in said set of parsimony values being equal to said parsimony number,
e) determine a smoothness value based on said input data set, such that, upon determining a generalized additive model on a subset of said input data set while using said smoothness value as a penalty parameter, said model has the highest out-of-sample score, and determining a set of smoothness values comprised based on said smoothness value, the number of smoothness values in said set of smoothness values being equal to said smoothness number,
f)
1. for each parsimony value in the set of parsimony values, determine a generalized additive model on said each of said non-identical subsets and said input data set while using said each parsimony value as a penalty parameter, and defining from the resulting model a set of active variables for which the coefficients are not null, thereby generating a number of sets of active variables equal to said number of input data set subsets plus one times said parsimony number, each of said sets of active variables being associated to a parsimony value and a subset or said input data set,
2. for each smoothness value, for each set of active variables, determine a generalized additive model on the subset or said input data set associated to said each set of active variables while using said each smoothness value as a penalty parameter, thereby generating a number models equal to said number of input data set subsets plus one times said parsimony number times said smoothness number, each model being associated to a smoothness value, a parsimony value, and a subset or said input data set, and
g) group the generalized additive models which are associated to the same couple of associated parsimony value and smoothness value, computing the k-fold scores for each group of generalized additive models and returning for each group of generalized additive models the generalized additive model associated to said input data set as well as the corresponding k-fold scores,
wherein in operations d), e) and f), determining a generalized additive model on a set of data using a penalty parameter includes optimizing a set of coefficients B=(bᵢⱼ) such that:
the prediction of a generalized additive model is [symbol] (X)=g(Σ_{i∈A}Σⱼb_{i,j}*Iₓ_{ᵢ}₌ⱼ) where X is the input variable for the prediction, g( ) is a function which depends on the distribution sought after, A is the set of active variables and Iₓ_{ᵢ}₌ⱼ is the indicatrices function valued at 1 if xᵢ is the j^{th} level, and 0 in other cases,
the determination is based on optimizing the set of coefficients B taking into account constraints depending on the penalty parameter, using a proximal gradient descent algorithm, wherein the constraints are defined as B*=ArgMax_{B}LogLikelihood(Y, [symbol] )−Pₚₐᵣₛh(B) for operations d) and f1), where Pₚₐᵣₛ is the penalty parameter and h( ) a penalty function, and as B*=ArgMax_{B}Likelihood(Y, [symbol] )−Pₛₘₒk(B) for operations e) and f2), where Pₛₘₒ is the penalty parameter and k( ) a penalty function.
